(19) United States
(12) Patent Application Publication
(10) Pub. No.: US 2026/0012783 A1
(43) Pub. Date: Jan. 8, 2026

(54) POLICY LEARNING METHOD WITH PRIVACY PROTECTION IN MOBILE EDGE COMPUTING FOR INTELLIGENT AGENT

(71) Applicant: CHONGQING UNIVERSITY OF POSTS AND TELECOMMUNICATIONS, Chongqing (CN)

(72) Inventors: Yun LI, Chongqing (CN); Bi WANG, Chongqing (CN); Shichao XIA, Chongqing (CN); Zhixiu YAO, Chongqing (CN); Qian GAO, Chongqing (CN); Hongcheng ZHUANG, Chongqing (CN)

(73) Assignee: CHONGQING UNIVERSITY OF POSTS AND TELECOMMUNICATIONS, Chongqing (CN)

(21) Appl. No.: 18/684,881

(22) PCT Filed: Jun. 20, 2023
(86) PCT No.: PCT/CN2023/101255

§ 371 Date: Sep. 26, 2025

(30) Foreign Application Priority Data
Jun. 12, 2023 (CN) 202310686533.9

(51) Int. Cl. H04W 12/02; G06N 3/092

(52) U.S. Cl. CPC H04W 12/02; G06N 3/092

(57) ABSTRACT

A policy learning method with privacy protection in mobile edge computing for an intelligent agent is provided, relating to the technical field of mobile communication. The method includes: establishing an edge-collaborative computing offloading model, where the edge-collaborative computing offloading model includes a service caching model, a task offloading model, and a system cost model; establishing an optimization problem for task offloading, service caching, computing resource allocation and transmission power control based on the edge-collaborative computing offloading model for minimizing task processing costs; abstracting the optimization problem to a partially observable Markov decision process; and autonomously learning a task offloading strategy, a service caching strategy, a computing resource allocation strategy, and a transmission power control strategy by using a federated learning-based multi-agent deep reinforcement learning algorithm based on the Markov decision process.

This application claims the priority to Chinese Patent Application No. 202310686533.9 titled “POLICY LEARNING METHOD WITH PRIVACY PROTECTION IN MOBILE EDGE COMPUTING FOR INTELLIGENT AGENT”, filed on Jun. 12, 2023 with the China National Intellectual Property Administration (CNIPA), which is incorporated herein by reference in its entirety.

### FIELD

The present disclosure relates to the technical field of mobile communication, and in particular to a policy learning method with privacy protection in mobile edge computing for an intelligent agent.

### BACKGROUND

Based on Mobile edge computing (MEC), storage and processing of tasks of users are pushed edges of a mobile communication network, so that the users can be served with high reliability and low delay at the edges of the network, providing powerful technical support for efficient processing of the users' services, and thereby meeting the efficient and rapid service quality requirements of the users. However, with the integration and vigorous development of communication technology and Internet of Things technology, the structures of edge networks are becoming increasingly dense and heterogeneous. In an edge network environment, the efficiencies of network service caching and resource allocation in a computing network are constrained due to the wide-area differentiation of services, the high dynamism of network environments, the decentralization of the resource deployment in the computing network and other features. A crucial problem in the MEC is how to design and implement an efficient task offloading solution, an efficient service caching solution, and an efficient resource allocation solution for a decentralized structure of the edge network and diverse service requirements of the users.

Deep reinforcement learning has advantages of both deep learning and reinforcement learning, which may perceive and make a decision. The theoretical technologies related to the deep reinforcement learning are applied in the field of wireless communications by researchers. The following achievements are obtained. (1) In deep-reinforcement-learning-based offloading scheduling for vehicular edge computing (Zhan W, Luo C, Wang J, et al. IEEE Internet of Things Journal, 2020, 7(6): 5449-5465.), a problem of computing offloading scheduling in a vehicular edge computing scenario is studied. A stochastic optimization problem for task offloading and scheduling is established with a goal of minimizing a long-term task processing cost, a deep reinforcement learning algorithm based on a progressive optimization strategy is provided, and a strategy function and a value function are approximated by using a parameter sharing network and a convolutional neural network. (2) In dynamic offloading for multiuser muti-CAP MEC networks: a deep reinforcement learning approach [J] (Li C, Xia J, Liu F, et al. IEEE Transactions on Vehicular Technology, 2021, 70(3): 2922-2927.), a problem of dynamic offloading for a multiuser MEC network is abstracted as a Markov decision process, and then a DQN-based offloading strategy is designed, so that the users may dynamically adjust a proportion of task offloading, ensuring performance of a system. However, in the conventional DRL algorithm, it is required for a terminal device to transfer private data of the terminal device to an edge server or a remote cloud center for processing or training, and the data may be stolen or tampered with by a third party during transmission and processing, resulting in a risk of the data and sensitive information of the users being leaked.

Therefore, with the increasing attention of the users for privacy and security, how to protect privacy and security of the users, while designing flexible and efficient distributed task offloading, resource allocation and service caching strategies, is a problem to be solved urgently in current research.

In summary, the problem in the conventional technology is that in the conventional DRL algorithm, it is required for a terminal device to transfer private data of the terminal device to an edge server or a remote cloud center for processing or training, and the data may be stolen or tampered with by a third party during transmission and processing, resulting in a risk of the data and sensitive information of the users being leaked.

### SUMMARY

In order to solve the above technical problem, a policy learning method with privacy protection in mobile edge computing for an intelligent agent is provided according to the present disclosure. The method includes:
step S1, establishing an edge-collaborative computing offloading model for a decentralized MEC (mobile edge computing) scenario, where the edge-collaborative computing offloading model includes a service caching model, a task offloading model, and a system cost model;
step S2, establishing, based on multidimensional resources, an optimization problem for task offloading, service caching, computing resource allocation and transmission power control by using the edge-collaborative computing offloading model for minimizing task processing costs, where the multidimensional resources include computing resources and storage resources;
step S3, abstracting the optimization problem for task offloading, service caching, computing resource allocation and transmission power control to a partially observable Markov decision process; and
step S4, autonomously learning a task offloading strategy, a service caching strategy, a computing resource allocation strategy and a transmission power control strategy by using a federated learning-based multi-agent deep reinforcement learning algorithm based on the Markov decision process.

The present disclosure has the following beneficial effects.

In the present disclosure, service caching and resource allocation in the decentralized MEC scenario are researched while considering the privacy protection of the users. First, an edge-collaborative computing offloading model is established. Then, an optimization process is performed on task offloading, service caching, computing resource allocation and transmission power control for minimizing task processing costs, and the optimization process is abstracted to a partially observable Markov decision process. Then, a task offloading strategy, a service caching strategy, a computing resource allocation strategy, and a transmission power control strategy are autonomously learned by using a federated learning-based multi-agent deep reinforcement learning algorithm. In a centralized training phase of a multi-agent model, the problem of data security and privacy leakage exists, and a federated learning-based distributed model training method is adopted. In the training process, the actor current network updates the network parameter by maximizing a policy gradient, the critic current network updates the network parameter based on the loss function, and the actor target network and the critic target network update the network parameters in a soft update manner. Policy learning is performed based on the trained multi-agent model, fully protecting the privacy and security of data and sensitive information of the users.

### BRIEF DESCRIPTION OF THE DRAWINGS

FIG. 1 is a schematic diagram of an MEC system model according to the present disclosure;

FIG. 2 is a block diagram showing an MADDPG-based service caching and resource allocation algorithm according to the present disclosure;

FIG. 3 shows a federated learning-based model training process according to the present disclosure;

FIG. 4 is a schematic diagram showing a variation process of an average cost with the number of training iterations according to the present disclosure; and

FIG. 5 a schematic diagram showing a variation process of an average cache hit rate with the number of training iterations according to the present disclosure.

### DETAILED DESCRIPTION

Technical solutions in embodiments of the present disclosure are described clearly and completely in conjunction with the drawings in the embodiments of the present disclosure hereinafter. It is apparent that the described embodiments are only some embodiments of the present disclosure, rather than all embodiments. All other embodiments obtained by those skilled in the art based on the embodiments of the present disclosure without any creative work fall within the protection scope of the present disclosure.

A policy learning method with privacy protection in mobile edge computing for an intelligent agent includes the following steps S1 to S4.

In step S1, an edge-collaborative computing offloading model is established for a decentralized MEC scenario. The edge-collaborative computing offloading model includes a service caching model, a task offloading model, and a system cost model.

In step S2, an optimization problem for task offloading, service caching, computing resource allocation and transmission power control is established based on multidimensional resources by using the edge-collaborative computing offloading model for minimizing task processing costs. The multidimensional resources include computing resources and storage resources.

In step S3, the optimization problem for task offloading, service caching, computing resource allocation and transmission power control is abstracted to a partially observable Markov decision process.

In step S4, a task offloading strategy, a service caching strategy, a computing resource allocation strategy, and a transmission power control strategy are autonomously learned by using a federated learning-based multi-agent deep reinforcement learning algorithm based on the Markov decision process.

### 1. System Model

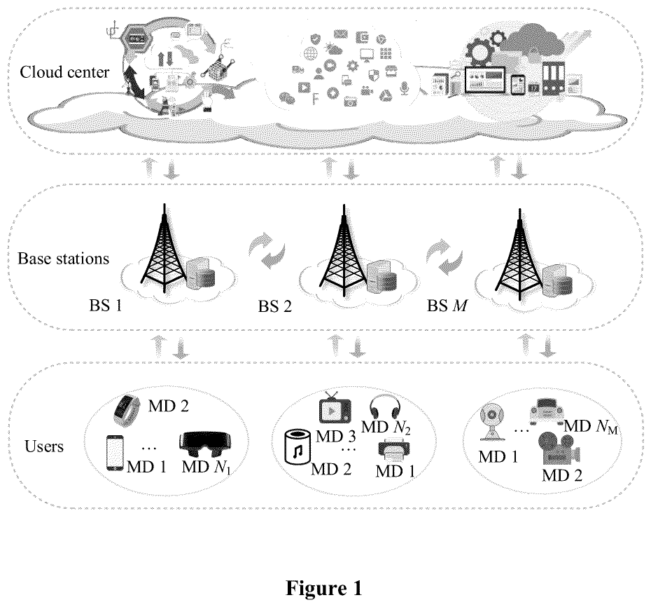

As shown in FIG. 1, a typical MEC system is considered in the present disclosure. In the MEC system, M base stations (BSs) are arranged, and a set of the base stations is defined as M={1, 2, . . . , M}. Each of the base stations is provided with an MEC server having computing and storing capabilities. Nₘ end users (EUs) operate within a coverage range of a BSm, and a set of the users is defined as Nₘ={1, 2, . . . ,}. The system operates in discrete time slots, and the time slots are defined as T={1, 2, . . . , T}. In a time slot t, a task generated by a user EU iₘ is defined as dᵢ_{ₘ}_{,m}(t)=(Dᵢ_{ₘ}_{,m}(t),Cᵢ_{ₘ}_{,m}(t), Xᵢ_{ₘ}_{,m}, Fᵢ_{ₘ}_{,m}), where Dᵢ_{ₘ}_{,m}(t) represents the amount of data (in bits) of the task, Cᵢ_{ₘ}_{,m}(t) represents a maximum tolerable delay for processing the task of the user iₘ, Xᵢ_{ₘ}_{,m} represents the number of CPU cycles for processing a task of a unit bit, and Fᵢ_{ₘ}_{,m}, represents a service type for processing the task. Therefore, a set of tasks of all the users of the base station BSm may be defined as dₘ(t)={d_{1,m}(t), d_{2,m}(t), . . . , d_{N}_{ₘ}_{,m}(t)}

### (1) Service Caching Model

In the present disclosure, it is assumed that K service types are provided in a network, and a set of the service types is defined as K={1, 2, . . . , K}. a_{k,m}(t)∈{0,1} represents a caching indication function of a service k in BSm in a time slot t. a_{k,m}(t)=1 indicates that the BSm caches the service k. a_{k,m}(t)=0 indicates that the BSm does not cache the service k. Furthermore, a service caching decision of the BSm in the time slot t may be represented as a set of service caching strategies aₘ(t)={a_{1,m}(t), . . . , a_{k,m}(t), . . . , a_{K,m}(t)}. Due to a limited storage space of an MEC server, a storage space occupied by the cached services does not exceed a storage capacity of the MEC server. Rₘ represents a size of a storage space of the base station m in the MEC,

$${\sum }_{k = 1}^{K} {a}_{k , m} ( t ) \cdot {l}_{k} \leq {R}_{m} , ∀ m ∈ M , t ∈ T ,$$

where lₖ represents a size of a storage space occupied by the service k.

### (2) Task Offloading Model

The task generated by the user EU iₘ may be processed locally or be offloaded to a base station or a cloud for processing. Therefore, the task generated by the EU iₘ may be processed locally, or be offloaded to an associated base station BSm for processing, or be forwarded from an associated base station BSm to a nearby base station BSn (where n∈M and n≠m) for processing, or be offloaded to a cloud for processing. An offloading decision variable of the EU iₘ is defined as φᵢ_{ₘ}_{,l}(t), φᵢ_{ₘ}_{,m}(t), φᵢ_{ₘ}_{,n,m}(t), φᵢ_{ₘ}_{,c}(t)∈{0,1}. φᵢ_{ₘ}_{,l}(t)=1 indicates that the task of the user EU iₘ is processed locally, and φᵢ_{ₘ}_{,l}(t)=0 indicates that the task of the user EU iₘ is not processed locally. φᵢ_{ₘ}_{,m}(t)=1 indicates that the task of the user EU iₘ is offloaded to an associated base station BSm for processing, and φᵢ_{ₘ}_{,m}(t)=0 indicates that the task of the user EU iₘ is not offloaded to the associated base station BSm for processing. φᵢ_{ₘ}_{,m,n}(t)=1 indicates that the task of the user EU iₘ is forwarded from a base station BSn to the base station BSm for processing, and φᵢ_{ₘ}_{,m,n}(t)=0 indicates that the task of the user EU iₘ is not forwarded from the base station BSn to the base station BSm for processing. φᵢ_{ₘ}_{,c}(t)=1 indicates that the task of the user EU iₘ is offloaded to the cloud for processing, and φᵢ_{ₘ}_{,c}(t)=0 indicates that the task of the user EU iₘ is not offloaded to the cloud for processing. φᵢ_{ₘ}_{,l}(t), φᵢ_{ₘ}_{,m}(t), φᵢ_{ₘ}_{,n,m}(t), φᵢ_{ₘ}_{,c}(t) meet φᵢ_{ₘ}_{,l}(t)+φᵢ_{ₘ}_{,m}(t)+φᵢ_{ₘ}_{,m,n}(t)+φᵢ_{ₘ}_{,c}(t)=1. Therefore, in a time slot t, a task offloading strategy of the EU iₘ may be expressed as bᵢ_{ₘ}(t)={φᵢ_{ₘ}_{,l}(t), φᵢ_{ₘ}_{,m}(t), φᵢ_{ₘ}_{,m,n}(t), φᵢ_{ₘ}_{,c}(t)}, and a task offloading decision for all the users of the base station BSm may be expressed as bₘ={b_{1,m}, b_{2,m}, . . . , b_{N}_{ₘ}_{,m}}.

### (i) Local Processing

In a case that the task is processed locally, φᵢ_{ₘ}_{,l}(t)=1. fᵢ_{ₘ}_{,m} represents a local CPU frequency of the user EU iₘ a local processing delay of the task may be expressed as

$${T}_{{i}_{m} , l}^{loc} ( t ) = \frac{{D}_{{i}_{m} , m} ( t ) {X}_{{i}_{m} , m}}{{f}_{{i}_{m} , m}} ,$$

and a task processing energy consumption of the task may be expressed as

$${E}_{{i}_{m} , l}^{loc} ( t ) = {kD}_{{i}_{m} , m} ( t ) {X}_{{i}_{m} , m} {f}_{{i}_{m} , m}^{2} ,$$

where k represents an effective capacitance coefficient based on a chip architecture.

### (ii) Offloading to an Associated Base Station for Processing

In a case that the base station BSm caches the service k for processing a task of the user, the task of the user EU iₘ may be directly offloaded to the base station BSm for processing, that is, φᵢ_{ₘ}_{,m}(t)=1. Bₘ represents a bandwidth of the base station BSm and Hₘ represents the total number of uplink channels, then a sub-channel bandwidth may be obtained by

$${ω}_{m} = \frac{{B}_{m}}{{H}_{m}} .$$

Based on Shannon's formula, a speed for updating the task may be obtained by using the equation

$${r}_{{i}_{m} , m} ( t ) = {ω}_{m} log ( 1 + \frac{{P}_{{i}_{m} , m} ( t ) {G}_{{i}_{m} , m}}{{σ}^{2} ( t )} ) ,$$

where Pᵢ_{ₘ}_{,m}(t) represents a transmission power of the user EU iₘ in the time slot t, Gᵢ_{ₘ}_{,m} represents a channel gain between the user EU iₘ and the BSm, and σ²(t) represents a power of an additive Gaussian white noise in the time slot t.

In a case that the task of the user EU iₘ is offloaded to the associated base station BSm for processing, the processing delay of the task includes a transmission delay and an execution delay, that is,

$${T}_{{i}_{m} , m}^{bs} ( t ) = \frac{{D}_{{i}_{m} , m} ( t )}{{r}_{{i}_{m} , m} ( t )} + \frac{{D}_{{i}_{m} , m} ( t ) {X}_{{i}_{m} , m}}{{β}_{{i}_{m} , m} ( t ) {f}_{m}^{bs}} \cdot {f}_{m}^{bs}$$

represents a total computing resource of the base station BSm. βᵢ_{ₘ}_{,m}(t) represents a CPU frequency allocation coefficient assigned by the BSm for the user EU iₘ in the time slot t, and meets 0≤βᵢ_{ₘ}_{,m}(t)≤1.

$${β}_{{i}_{m} , m} ( t ) {f}_{m}^{bs}$$

represents a CPU frequency allocated by the BSm for the user EU iₘ. A computing resource allocation strategy of the BSm may be expressed as βₘ (t)={β_{1,m}(t), . . . , β_{N}_{ₘ}_{,m}(t)}.

The task processing energy consumption may be expressed as

$${E}_{{i}_{m} , m}^{bs} ( t ) = {P}_{{i}_{m} , m} ( t ) \frac{{D}_{{i}_{m} , m} ( t )}{{r}_{{i}_{m} , m} ( t )} + {D}_{{i}_{m} , m} ( t ) {e}_{bs} ,$$

where e_{bs} represents an energy consumption for processing a task of a unit bit by the base station.
(iii) Offloading to a Nearby Base Station for Processing

In a case that the associated base station BSm does not cache the service k for processing the task of the user, and a nearby base station BSn caches the service k, the task of the EU iₘ may be forwarded from the base station BSm to the nearby base station BSn for processing, that is, φᵢ_{ₘ}_{,m,n}(t)=1. A forwarding speed of the BSm is expressed as

$${r}_{{i}_{m} , m} ( t ) = {ω}_{m} log ( 1 + \frac{{P}_{m} ( t ) {G}_{m , n}}{{σ}^{2} ( t )} ) ,$$

where Pₘ(t) represents a transmission power of the BSm in the time slot t, and G_{m,n} represents a channel gain between the BSm and the BSn. The processing delay of the task includes a transmission delay, a forwarding delay and an execution delay, that is,

$${T}_{{i}_{m} , m , n}^{bs} ( t ) = \frac{{D}_{{i}_{m} , m} ( t )}{{r}_{{i}_{m} , m} ( t )} + \frac{{D}_{{i}_{m} , m} ( t )}{{r}_{m , n} ( t )} + \frac{{D}_{{i}_{m} , m} ( t ) {X}_{i}}{{β}_{i , n} ( t ) {f}_{n}^{bs}} .$$

The task processing energy consumption is expressed as

$${E}_{{i}_{m} , m , n}^{bs} ( t ) = {P}_{{i}_{m} , m} ( t ) \frac{{D}_{{i}_{m} , m} ( t )}{{r}_{{i}_{m} , m} ( t )} + {P}_{m} ( t ) \frac{{D}_{{i}_{m} , m} ( t )}{{r}_{m , n} ( t )} + {D}_{{i}_{m} , m} ( t ) {e}_{bs} .$$

### (iv) Offloading to a Cloud for Processing

In a case that the associated base station BSm does not cache the service k for processing the task of the user, the user EU iₘ may offload the task to a cloud for processing, that is, φᵢ_{ₘ}_{,c}(t)=1. Without considering the execution delay and energy consumption of the task, the processing delay of the task may be expressed as

$${T}_{{i}_{m} , c} ( t ) == \frac{{D}_{{i}_{m} , m} ( t )}{{r}_{{i}_{m} , m} ( t )} + \frac{{D}_{{i}_{m} , m} ( t )}{{r}_{m , c} ( t )} ,$$

where r_{m,c}(t) represents a transmission speed from the base station BSm to the cloud. The task processing energy consumption may be expressed as

$${E}_{{i}_{m} , c} ( t ) = {P}_{{i}_{m} , m} ( t ) \frac{{D}_{{i}_{m} , m} ( t )}{{r}_{{i}_{m} , m} ( t )} + {P}_{m , c} ( t ) \frac{{D}_{{i}_{m} , m} ( t )}{{r}_{m , c} ( t )} ,$$

where P_{m,c}(t) represents a transmission power from the base station BSm to the cloud.

### (3) System Cost Model

Based on a predetermined the task offloading decision, a predetermined computing resource allocation decision and a predetermined service caching decision, a processing delay of a task dᵢ_{ₘ}_{,m}(t) of the user EU iₘ may be expressed as:

$${T}_{{i}_{m} , m} ( t ) = \{ \begin{matrix}{T}_{{i}_{m} , l}^{loc} ( t ) , & {φ}_{{i}_{m} , l} ( t ) = 1 \\ {T}_{{i}_{m} , m}^{bs} ( t ) , & {φ}_{{i}_{m} , m} ( t ) = 1 \\ {T}_{{i}_{m} , m , n}^{bs} ( t ) , & {φ}_{{i}_{m} , m , n} ( t ) = 1 \\ {T}_{{i}_{m} , c} ( t ) , & {φ}_{{i}_{m} , c} ( t ) = 1\end{matrix}$$

A task processing energy consumption of the task dᵢ_{ₘ}_{,m}(t) may be expressed as:

$${E}_{{i}_{m} , m} ( t ) = \{ \begin{matrix}{E}_{{i}_{m} , l}^{loc} ( t ) , & {φ}_{{i}_{m} , l} ( t ) = 1 \\ {E}_{{i}_{m} , m}^{bs} ( t ) , & {φ}_{{i}_{m} , m} ( t ) = 1 \\ {E}_{{i}_{m} , m , n}^{bs} ( t ) , & {φ}_{{i}_{m} , m , n} ( t ) = 1 \\ {E}_{{i}_{m} , c} ( t ) , & {φ}_{{i}_{m} , c} ( t ) = 1\end{matrix}$$

The cost for processing the task dᵢ_{ₘ}_{,m}(t) of the user EU iₘ may be expressed as cᵢ_{ₘ}_{,m}(t)=αᵢ_{ₘ}_{,m}Tᵢ_{ₘ}_{,m}(t)+εᵢ_{ₘ}_{,m}Eᵢ_{ₘ}_{,m}(t), where αᵢ_{ₘ}_{,m} represents a weight coefficient of the delay, εᵢ_{ₘ}_{,m} represents a weight coefficient of the processing energy consumption, and αᵢ_{ₘ}_{,m} and εᵢ_{ₘ}_{,m} meet

$$\{ \begin{matrix}{α}_{{i}_{m} , m} + {ε}_{{i}_{m} , m} = 1 \\ 0 \leq {α}_{{i}_{m} , m} \leq 1 \\ 0 \leq {ε}_{{i}_{m} , m} \leq 1\end{matrix} . {T}_{{i}_{m} , l}^{loc} ( t )$$

represents a processing delay for processing the task locally,

$${T}_{{i}_{m} , m}^{bs} ( t )$$

represents a processing delay for processing the task at an associated base station,

$${T}_{{i}_{m} , m , n}^{bs} ( t )$$

represents a processing delay for processing the task at a nearby base station, and Tᵢ_{ₘ}_{,c}(t) represents a processing delay for processing the task at a cloud. φᵢ_{ₘ}_{,l}(t) represents that the task of the user i is processed locally, φᵢ_{ₘ}_{,m}(t) represents that the task of the user i is offloaded to an associated base station m for processing, φᵢ_{ₘ}_{,m,n}(t) represents that the task of the user i is forwarded from the base station m to a base station n for processing, and φᵢ_{ₘ}_{,c}(t) represents that the task of the user i is offloaded to the cloud for processing.

$${E}_{{i}_{m} , l}^{loc} ( t )$$

represents a processing energy consumption for processing the task locally,

$${E}_{{i}_{m} , m}^{bs} ( t )$$

represents a processing energy consumption for processing the task at the associated base station,

$${E}_{{i}_{m} , m , n}^{bs} ( t )$$

represents a processing energy consumption for processing the task at the nearby base station, and Eᵢ_{ₘ}_{,c}(t) represents a processing energy consumption for processing the task at the cloud.

### 2. Problem Description

Due to the limited resources (such as the computing and storage space) of the server, task offloading and resource allocation are coupled. In view of this, a joint optimization problem of service caching, computing resource allocation, and transmission power control is established according to the present disclosure for minimizing a long-term average task processing cost. The joint optimization problem is modeled as:

$${min}_{a ( t ) , b ( t ) , β ( t ) , P ( t )} \frac{1}{T} \frac{1}{M} {\sum }_{t = 1}^{T} {\sum }_{m = 1}^{M} {\sum }_{{i}_{m} = 1}^{{N}_{m}} {c}_{{i}_{m} , m} ( t )$$

$$s . t {T}_{{i}_{m} , m} ( t ) \leq {C}_{{i}_{m} , m} ( t ) , ∀ {i}_{m} , ∀ m$$

$${\sum }_{k = 1}^{K} {a}_{k , m} ( t ) \cdot {l}_{k} \leq {R}_{m} , {a}_{k , m} ( t ) ∈ \{ 0 , 1 \} , ∀ {i}_{m} , ∀ m$$

$${\sum }_{i = 1}^{N} {β}_{{i}_{m} , m} ( t ) \leq 1 , 0 \leq {β}_{{i}_{m} , m} ( t ) \leq 1 , ∀ {i}_{m} , ∀ m$$

$${φ}_{{i}_{m} , l} ( t ) , {φ}_{{i}_{m} , m} ( t ) , {φ}_{{i}_{m} , m , n} ( t ) , {φ}_{{i}_{m} , c} ( t ) ∈ \{ 0 , 1 \} , ∀ {i}_{m} , ∀ m$$

$${φ}_{{i}_{m} , l} ( t ) + {φ}_{{i}_{m} , m} ( t ) + {φ}_{{i}_{m} , m , n} ( t ) + {φ}_{{i}_{m} , c} ( t ) = 1 , ∀ {i}_{m} , ∀ m$$

where a(t)={a₁(t), . . . , a_{M}(t)} represents a service caching strategy for a base station, b(t)={b₁(t), . . . , b_{M}(t)} represents a task offloading strategy, β(t)={β₁(t), . . . , β_{M}(t)}represents a computing resource allocation strategy for the base station, P(t)={P₁(t), P₂(t), . . . , P_{M}(t)} and Pₘ(t)={P_{1,m}(t),P_{2,m}(t), . . . , P_{N}_{ₘ}_{,m}} represent a transmission power control decision, M represents the number of base stations, T represents a time slot, Nₘ represents the number of end users, cᵢ_{ₘ}_{,m}(t) represents a cost of processing a task dᵢ_{ₘ}_{,m}(t) of a user iₘ, Tᵢ_{ₘ}_{,m}(t) represents a processing delay of the task dᵢ_{ₘ}_{,m}(t) of the user iₘ, a_{k,m}(t) represents a caching decision for a service k of a base station m in a time slot t, lₖ represents a size of a storage space occupied by the service k, Rₘ represents a size of a storage space of a server of an m-th base station in the MEC scenario, and βᵢ_{ₘ}_{,m}(t) represents a CPU frequency allocation coefficient allocated by the base station m for the user iₘ in the time slot t, φᵢ_{ₘ}_{,l}(t) represents that the task of the user i is processed locally, φᵢ_{ₘ}_{,m}(t) represents that the task of the user i is offloaded to the associated base station m for processing, φᵢ_{ₘ}_{,m,n}(t) represents that the task of the user i is forwarded from the base station n to the base station m for processing, and φᵢ_{ₘ}_{,c}(t) represents that the task of the user i is offloaded to the cloud for processing. K represents a service type, and N represents the number of users. The constraint of Tᵢ_{ₘ}_{,m}(t)≤Cᵢ_{ₘ}_{,m}(t), ∀iₘ, ∀m indicates that the processing delay of the task should not exceed a maximum tolerable delay. The constraint of

$${\sum }_{k = 1}^{K} {a}_{k , n} ( t ) \cdot {l}_{k} \leq {R}_{m} ,$$

a_{k,m}(t)∈{0,1}, ∀iₘ, ∀m indicates that the size of the cached service should not exceed the storage capacity of the BS. The constraint of

$${\sum }_{i = 1}^{N} {β}_{{i}_{m} , m} ( t ) \leq 1 ,$$

0≤βᵢ_{ₘ}_{,m}(t)≤1, ∀iₘ, ∀m indicates that the total amount of allocated computing resources should not exceed a total computing capacity of the server. The constraint of φᵢ_{ₘ}_{,l}(t), φᵢ_{ₘ}_{,m} (t), φᵢ_{ₘ}_{,m,n}(t), φᵢ_{ₘ}_{,c}(t)∈{0,1}, •iₘ, ∀m and the constraint of φᵢ_{ₘ}_{,l}(t)+φᵢ_{ₘ}_{,m}(t)+φᵢ_{ₘ}_{,m,n}(t)+φᵢ_{ₘ}_{,c}(t)=1, ∀iₘ, ∀m indicate that the user decides to process the task only in one manner.

### 3. Solving a Problem Based on Federated Multi-Agent Deep Reinforcement Learning

A distributed service caching and resource allocation algorithm (DSCRA) based on federated multi-agent deep reinforcement learning is designed according to the present disclosure, in which the base station serves as an intelligent agent, learns the task offloading strategy, the service caching strategy, the computing resource allocation strategy and the transmission power control strategy, and provides privacy protection for the users. Considering different local models, an attention mechanism is adopted in performing parameter aggregation, and different parameter weights are assigned for different local models.

### (1) Problem Conversion

The cost minimization problem described above is abstracted to a partially observable Markov decision process. A base station serves as the intelligence agent, and a tuple {S,O,A,R} is defined to describe the Markov game process, where S represents a global state space, an environment in a time slot t is a global state s(t)∈S, O={O₁, O₂, . . . , O_{M}} represents a set of observation spaces for the intelligent agent, A={A₁, A₂, . . . , A_{M}} represents a set of global action spaces, and R={R₁,R₂, . . . , R_{M}} represents a set of rewards. In the time slot t, the intelligent agent m, according to a strategy πₘ:Oₘ→Aₘ, selects an action aₘ(t)∈Aₘ based on a local observation oₘ(t)∈Oₘ to obtain a corresponding reward rₘ(t)∈Rₘ.

### (i) State Space

In the time slot t, an environment state may be defined as

$$s ( t ) = \{ {d}_{1} ( t ) , {d}_{2} ( t ) , … , {d}_{M} ( t ) , {P}_{1} ( t ) , {P}_{2} ( t ) , … , {P}_{M} ( t ) , {f}_{1} , {f}_{2} , … , {f}_{M} , {B}_{1} , {B}_{2} , … , {B}_{M} , {f}_{1}^{b s} , {f}_{2}^{b s} , … , {f}_{M}^{b s} , {G}_{1} , {G}_{2} , … , {G}_{M} \}$$

where fₘ={f_{1,m}, f_{2,m}, . . . , f_{N}_{ₘ}_{,m}} represents a set of local CPU frequencies for the users of the base station BSm, and Gₘ={G_{1,m}, . . . , G_{N}_{ₘ}_{,m}} represents a set of channel gains of the users of the base station BSm. In the time slot t, the environmental state oₘ(t)∈Oₘ observed by the intelligent agent m is defined as

$${o}_{m} ( t ) = \{ {d}_{m} ( t ) , {f}_{m} , {f}_{m}^{b s} , {B}_{m} \} .$$

### (ii) Action Space

The intelligent agent m selects an action from the action spaces based on the observed environmental state oₘ(t) and a current strategy πₘ. In the time slot t, the action aₘ(t)∈Aₘ of the intelligent agent m is defined as:

$${a}_{m} ( t ) = \{ {b}_{m} ( t ) , {β}_{m} ( t ) , {a}_{m} ( t ) , {P}_{m} ( t ) \}$$

where bₘ(t) represents task offloading actions of all the users of the BSm, βₘ(t) represents a computing resource allocation action of the BSm, aₘ(t) represents a service caching action of the BSm, and Pₘ(t) represents transmission power control actions of all the users of the BSm.

(iii) Reward Function

Based on the reward function, an effect of the intelligent agent performing an action in a predetermined state is determined. In a training process, in a case that the intelligent agent performs an action in a time slot t−1, a corresponding reward is to be returned to the intelligent agent in a time slot t. Based on the returned reward, the intelligent agent may update a strategy to obtain an optimal result. Due to the reward, each of intelligent agents obtains an optimal strategy, and directly determines a corresponding task offloading strategy, a corresponding computing resource allocation strategy for the base station, a corresponding service caching strategy, and a corresponding transmission power control decision. Therefore, the reward function should be designed based on the original optimization problem. The reward in the present disclosure includes the following three parts: a reward for task processing cost; a reward for the processing delay of the task meeting a delay constraint, that is, Yᵢ_{ₘ}_{,m}(t)=λ₁H(Cᵢ_{ₘ}_{,m}(t)−Tᵢ_{ₘ}_{,m}(t)); and a reward for caching not exceeding a storage capacity of an edge server, that is,

$${U}_{{i}_{m} , m} ( t ) = {λ}_{2} H ( {R}_{m} - {\sum }_{k = 1}^{K} {a}_{k , m} ( t ) \cdot {l}_{k , m} ( t ) ) .$$

The optimization is performed to minimize the long-term average task processing cost and maximize the long-term reward. Therefore, a cumulative reward of the intelligent agent m is expressed as

$${r}_{m} ( t ) = {\sum }_{{i}_{m} = 1}^{{N}_{m}} ( {Y}_{m} ( t ) - {c}_{{i}_{m} , m} ( t ) ) + {U}_{m} ( t ) ,$$

where H (□) represents a Heaviside step function, and λ₁ and λ₂ represent weight coefficients.

### (2) DSCRA Algorithm

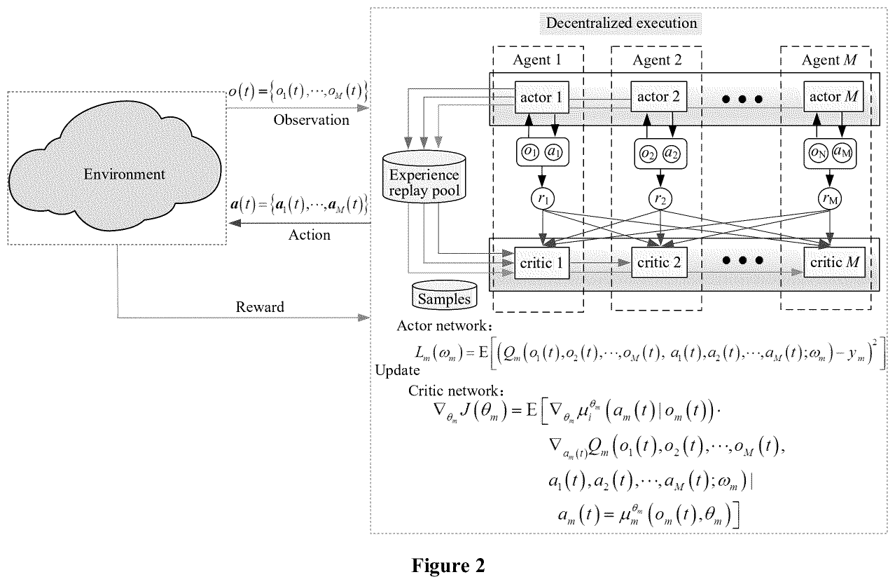

As shown in FIG. 2, a MADDPG model is an actor-critic-based algorithm. Base stations serve as intelligent agents. Each of the intelligent agents includes an actor network and a critic network. The actor network includes two deep neural networks: an actor current network and an actor target network. The critic network includes two deep neural networks: a critic current network and a critic target network. In a training phase, the actor network and the critic network update network parameters through federated learning. The critic current network updates a network parameter by minimizing a loss function. The actor current network updates a network parameter θ by maximizing a policy gradient based on a centralized Q-function calculated by the critic current network and observation information of the actor current network. The actor target network and the critic target network update parameters in a soft update manner, and perform parameter aggregation based on an attention mechanism. An experience replay memory D stores a tuple

$$D = \{ {o}_{m} ( t ) , {a}_{m} ( t ) , {r}_{m} ( t ) , o {}_{m}^{′} ( t + 1 ) \}$$

that is related to observations and actions in the training phase, and is expressed as, where oₘ(t) represents an observation state of an intelligent agent i in a time slot t, aₘ(t) represents an action performed by an intelligent agent m in the time slot t based on the current observation oₘ(t), rₘ(t) represents an obtained reward after the intelligent agent m performs the action aₘ(t) in the time slot t, and

$$o {}_{m}^{′} ( t + 1 )$$

represents a state of the intelligent agent m in a time slot t+1.

In a decentralized execution phase, an actor network of each of the intelligent agents performs an action

$${a}_{m} ( t ) = {μ}_{m}^{{θ}_{m}} ( {o}_{m} ( t ) ; {θ}_{m} )$$

based on the local observation state oₘ(t) and a strategy

$${μ}_{m}^{{θ}_{m}} : {O}_{m} \to {A}_{m}$$

of the actor network in the time slot t, where Oₘ represents a set of observation states of the intelligent agent m, Aₘ represents a set of action decisions of the intelligent agent m, and θₘ represents a parameter of the actor current network of the intelligent agent m.

In a centralized training phase, each of critic networks may obtain an observation oₘ(t) and an action aₘ(t) of another intelligent agent, and the Q-function of the intelligent agent m may be expressed as:

$${Q}_{m} ( {o}_{1} ( t ) , {o}_{2} ( t ) , … , {o}_{M} ( t ) , {a}_{1} ( t ) , {a}_{2} ( t ) , … , {a}_{M} ( t ) ; {ω}_{m} )$$

where Qₘ( ) represents the centralized Q-function, o₁(t), o₂(t), . . . , o_{M}(t) represent observation states of the intelligent agents, a₁ (t), a₂(t), . . . , a_{M}(t) represent actions performed by the intelligent agents, and ωₘ represents a parameter of the critic current network.

The Q-function evaluates actions of the actor network from a global perspective, and guides the actor network to select a preferred action. In training, the critic network updates the network parameter by minimizing the loss function. The loss function may be defined as:

$${L}_{m} ( {ω}_{m} ) = E [ {( {Q}_{m} ( {o}_{1} ( t ) , {o}_{2} ( t ) , … , {o}_{M} ( t ) , {a}_{1} ( t ) , {a}_{2} ( t ) , … , {a}_{M} ( t ) ; {ω}_{m} ) - {y}_{m} )}^{2} ]$$

$$where$$

$${y}_{m} = {r}_{m} + γ {Q}_{m}^{′} ( {o}_{1}^{′} ( t + 1 ) , o {}_{2}^{′} ( t + 1 ) , \text{} … , o {}_{M}^{′} ( t + 1 ) , a {}_{1}^{′} ( t + 1 ) , a {}_{2}^{′} ( t + 1 ) , … , a {}_{M}^{′} ( t + 1 ) ; ω {}_{m}^{′} )$$

and γ represents a discount factor.

The actor network updates the network parameter θ based on the centralized Q-function calculated by the critic network and the observation information of the actor network, and outputs an action a. The actor network updates the network parameter θ by maximizing the policy gradient. The policy gradient may be expressed as:

$${∇}_{{θ}_{m}} J ( {θ}_{m} ) = E [ {∇}_{{θ}_{m}} {μ}_{i}^{{θ}_{m}} ( {a}_{m} ( t ) \vert {o}_{m} ( t ) ) \cdot {∇}_{{a}_{m} ( t )} {Q}_{m} ( {o}_{1} ( t ) , {o}_{2} ( t ) , \text{} … , {o}_{M} ( t ) , {a}_{1} ( t ) , {a}_{2} ( t ) , … , {a}_{M} ( t ) ; {ω}_{m} ) \vert {a}_{m} ( t ) = {μ}_{m}^{{θ}_{m}} ( {o}_{m} ( t ) , {θ}_{m} ) ]$$

The actor target network and the critic target network update the parameters in the soft update manner based on the following equations:

$$θ {}_{m}^{′} = {τ}_{m}^{a} {θ}_{m} + ( 1 - {τ}_{m}^{a} ) {θ}_{m}$$

$$ω {}_{m}^{′} = {τ}_{m}^{c} {ω}_{m} + ( 1 - {τ}_{m}^{c} ) {ω}_{m}$$

where ∇ represents a gradient operation, J( ) represents a policy objective function to be optimized, E[ ] represents an expectation of a cumulative reward, θₘ represents the parameter of the actor current network of the intelligent agent m, oₘ(t) represents the observation state of the intelligent agent m, aₘ(t) represents an action decision of the intelligent agent m, Qₘ( ) represents the centralized Q-function, o₁(t), o₂(t), . . . , o_{M}(t) represent the observation states of the intelligent agents, a₁(t), a₂(t), . . . , a_{M}(t) represent the actions performed by the intelligent agents, ωₘ represents the parameter of the critic current network,

$$μ {}_{m}^{{θ}_{m}}$$

represents a strategy of the intelligent agent m,

$$θ {}_{m}^{′}$$

represents an updated parameter of the actor target network of the intelligent agent m,

$${ω}_{m}^{′}$$

represents an updated parameter of the critic target network of the intelligent agent m,

$${τ}_{m}^{a}$$

represents an update coefficient of the actor network, and

$${τ}_{m}^{c}$$

represents an update coefficient of the critic network.

### (3) Model Training Based on Federated Learning

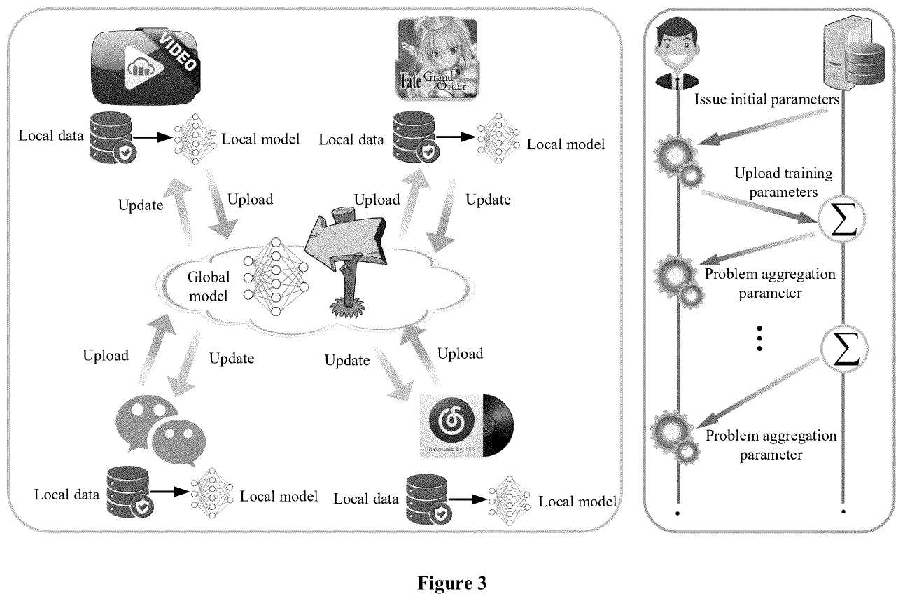

In the centralized training phase of the MADDPG model, The problems of data security and privacy leakage exist. In order to solve the problem of leakage of sensitive information and reduce the pressure of the edge computing while improving the network performance, the training is performed based on federated learning. The training model is shown in FIG. 3. In an initial phase, a base station obtains a global MADDPG model W(t) from a cloud center, and then the base station trains local models W₁(t), W₂(t), . . . , W_{M}(t) by using local data and the global model. Then, the trained local models are uploaded, and parameter aggregation is performed at the cloud center. Considering the different local models of the base station, the parameter aggregation is performed by using the attention mechanism, and different parameters are assigned for different local models. Reward and some indicators related to devices are used as contributions of the local models to the global model.

The weighted federated aggregation may be expressed as

$${min}_{ξ} \{ W ( t ) = {\sum }_{m ∈ M} {ξ}_{m} {W}_{m} ( t ) \} ,$$

where ξₘ represents a weight factor for evaluating the contributions of the local models to the global model. For the intelligent agent m, the weight factor ξₘ is calculated by using an average reward, an average loss, and a cache hit rate.

The average reward r̅ₘ(t) of the intelligent agent m is an average of all local rewards rₘ(t)

The average loss l̅o̅s̅s̅ of the intelligent agent m is an average of loss functions outputted in the training process.

The cache hit rate h̅ₘ is an average of cache hit rates hₘ in T time slots.

The above evaluation indicators may be expressed as Kₘ={r̅ₘ(t),l̅o̅s̅s̅,h̅ₘ}. The evaluation indicator vector Kₘ is modeled as a key of the attention mechanism, and a local model parameter Wₘ(t) of the intelligent agent m is modeled as a value of the attention mechanism. The model is established to obtain a more powerful intelligent agent, achieving a greater reward, a less loss, and a higher cache hit rate, that is,

$$Q = [ {max}_{m} ( {\overline{r}}_{m} ( t ) ) , {min}_{m} ( \overline{loss} ) , {max}_{m} ( {\overline{h}}_{m} ) ] .$$

Inputs of the base station include Q, a key Kₘ with a dimension of dₖ, and the value Wₘ(t). A dot product of Q and all keys is calculated, and then the dot product is divided by \sqrt{dₖ}. A weight of the value is obtained by using a softmax function, that is, the weight factor ξₘ may be expressed as:

$${ξ}_{m} = Attention ( Q , {K}_{m} ) = softmax ( \frac{{QK}_{m}^{T}}{\sqrt{{d}_{k}}} ) , ∀ m ∈ M .$$

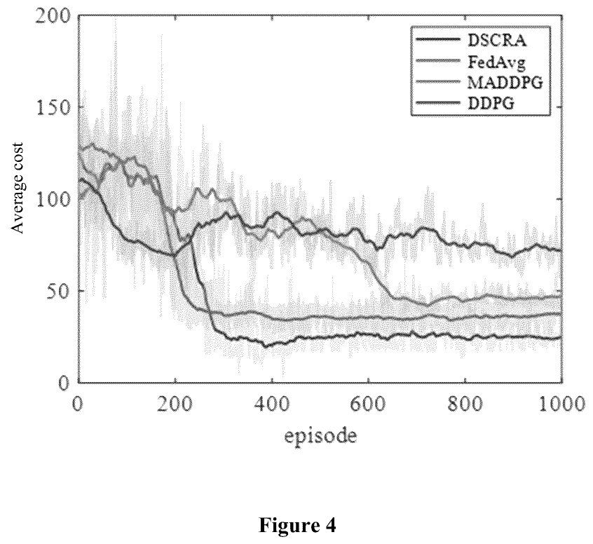

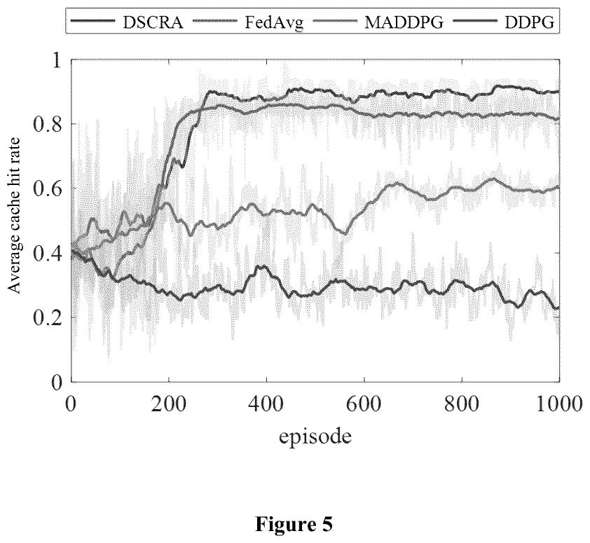

From FIG. 4, it can be seen that as the number of training iterations increases, the average task processing cost is continuously reduced and gradually stabilized, eventually achieving convergence. A lowest cost is achieved based on the DSCRA algorithm. It indicates that a preferred offloading strategy and a preferred resource allocation strategy may be obtained by using the DSCRA algorithm, thereby obtaining low task processing costs, and achieving on-demand resource allocation. Thus, the effectiveness of the algorithm is verified. From FIG. 5, it can be seen that as the number of training iterations increases, a curve of the cache hit rate has an upward trend and eventually reaches convergence, and a highest cache hit rate is achieved based on the DSCRA algorithm. Thus, the effectiveness of the algorithm is verified.

Although the embodiments of the present disclosure are illustrated and described, those skilled in the art can understand that various changes, modifications, substitutions and alterations can be made to these embodiments without departing from the principle and spirit of the present disclosure, and the scope of the present disclosure is defined by the claims and their equivalents.

1. A policy learning method with privacy protection in mobile edge computing for an intelligent agent, comprising:
step S1, establishing an edge-collaborative computing offloading model for a decentralized MEC (mobile edge computing) scenario, wherein the edge-collaborative computing offloading model comprises a service caching model, a task offloading model, and a system cost model;
step S2, establishing, based on multidimensional resources, an optimization problem for task offloading, service caching, computing resource allocation and transmission power control by using the edge-collaborative computing offloading model for minimizing task processing costs, wherein the multidimensional resources comprise computing resources and storage resources;
step S3, abstracting the optimization problem for task offloading, service caching, computing resource allocation and transmission power control to a partially observable Markov decision process; and
step S4, autonomously learning a task offloading strategy, a service caching strategy, a computing resource allocation strategy and a transmission power control strategy by using a federated learning-based multi-agent deep reinforcement learning algorithm based on the Markov decision process.

2. The policy learning method with privacy protection in mobile edge computing for an intelligent agent according to claim 1, wherein
in the decentralized MEC scenario, M base stations (BSs) are arranged in a MEC system, a set of the base stations is defined as M={1, 2, . . . , M}, and each of the M base stations is provided with an MEC server having computing and storage capabilities; Nₘ end users (EUs) operate within a coverage range of a base station m, and a set of the Nₘ users is defined as Nₘ={1, 2, . . . , Nₘ}; the system operates in discrete time slots, and the time slots are defined as T={1, 2, . . . , T}; in a time slot t, a task generated by a user iₘ is defined as dᵢ_{ₘ}_{,m}(t)=(Dᵢ_{ₘ}_{,m}(t), Cᵢ_{ₘ}_{,m}(t), Xᵢ_{ₘ}_{,m}, Fᵢ_{ₘ}_{,m}), Dᵢ_{ₘ}_{,m}(t) represents the amount of data (in bits) of the task, Cᵢ_{ₘ}_{,m}(t) represents a maximum tolerable delay for processing the task of the user iₘ, Xᵢ_{ₘ}_{,m} represents the number of CPU cycles for processing a task of a unit bit, and Fᵢ_{ₘ}_{,m} represents a service type for processing the task; and a set of tasks of all users of the base station m is defined as dₘ(t)={d_{1,m}(t), d_{2,m}(t), . . . , d_{N}_{ₘ}_{,m}(t)}.

3. The policy learning method with privacy protection in mobile edge computing for an intelligent agent according to claim 1, wherein
for the service caching model, it is assumed that K service types are provided in a network, a set of the service types is defined as K={1, 2, . . . , K}, a_{k,m}(t)∈{0,1} represents a caching indication function of a service k in a base station m in a time slot t, a_{k,m}(t)=1 indicates that the base station m caches the service k, a_{k,m}(t)=0 indicates that the base station m does not cache the service k, a service caching decision of the base station m in the time slot t is represented as a set of service caching strategies aₘ(t)={a_{1,m}(t), . . . , a_{k,m}(t), . . . , a_{K,m}(t)}, a storage space occupied by cached services does not exceed a storage capacity of an MEC server due to a limited storage space of the MEC server, Rₘ represents a size of a storage space of a server of an m-th base station in the MEC scenario,
$${\sum }_{k = 1}^{K} {a}_{k , m} ( t ) \cdot {l}_{k} \leq {R}_{m} , ∀ m ∈ M , t ∈ T ,$$
and lₖ represents a size of a storage space occupied by the service k.

4. The policy learning method with privacy protection in mobile edge computing for an intelligent agent according to claim 1, wherein
for the task offloading model, a task generated by a user iₘ is processed locally or is offloaded to a base station or a cloud for processing, a task offloading decision variable of the user iₘ is defined as φᵢ_{ₘ}_{,l}(t), φᵢ_{ₘ}_{,m}(t), φᵢ_{ₘ}_{,n,m}(t), φᵢ_{ₘ}_{,c}(t)∈{0,1}; φᵢ_{ₘ}_{,l}(t)=1 indicates that the task of the user i is processed locally, and φᵢ_{ₘ}_{,l}(t)=0 indicates that the task of the user iₘ is not processed locally; φᵢ_{ₘ}_{,m}(t)=1 indicates that the task of the user iₘ is offloaded to an associated base station m for processing, and φᵢ_{ₘ}_{,m}(t)=0 indicates that the task of the user iₘ is not offloaded to the associated base station m for processing; φᵢ_{ₘ}_{,m,n}(t)=1 indicates that the task of the user iₘ is forwarded from a base station n to the base station m for processing, and φᵢ_{ₘ}_{,m,n}(t)=0 indicates that the task of the user iₘ is not forwarded from the base station n to the base station m for processing; φᵢ_{ₘ}_{,c}(t)=1 indicates that the task of the user iₘ is offloaded to the cloud for processing, and φᵢ_{ₘ}_{,c}(t)=0 indicates that the task of the user iₘ is not offloaded to the cloud for processing; the equation of φᵢ_{ₘ}_{,l}(t)+φᵢ_{ₘ}_{,m}(t)+φᵢ_{ₘ}_{,m,n}(t)+φᵢ_{ₘ}_{,c}(t)=1 is met; and in a time slot t, a task offloading strategy of the EU iₘ is expressed as bᵢ_{ₘ}(t)={φᵢ_{ₘ}_{,l}(t), φᵢ_{ₘ}_{,m}(t), φᵢ_{ₘ}_{,m,n}(t), φᵢ_{ₘ}_{,c}(t)}, and a task offloading decision for all users of the base station m is expressed as bₘ {b_{1,m}, b_{2,m}, . . . , b_{N}_{ₘ}_{,m}}.

5. The policy learning method with privacy protection in mobile edge computing for an intelligent agent according to claim 1, wherein
for the system cost model, in a case that a task offloading decision and a service caching decision are determined, a processing delay of a task dᵢ_{ₘ}_{,m}(t) of a user iₘ is expressed as:
$${T}_{{i}_{m} , m} ( t ) = \{ \begin{matrix}{T}_{{i}_{m} , l}^{loc} ( t ) , & {φ}_{{i}_{m} , l} ( t ) = 1 \\ {T}_{{i}_{m} , m}^{bs} ( t ) , & {φ}_{{i}_{m} , m} ( t ) = 1 \\ {T}_{{i}_{m} , m , n}^{bs} ( t ) , & {φ}_{{i}_{m} , m , n} ( t ) = 1 \\ {T}_{{i}_{m} , c} ( t ) , & {φ}_{{i}_{m} , c} ( t ) = 1\end{matrix}$$
a processing energy consumption of the task dᵢ_{ₘ}_{,m}(t) of the user iₘ is expressed as:
$${E}_{{i}_{m} , m} ( t ) = \{ \begin{matrix}{E}_{{i}_{m} , l}^{loc} ( t ) , & {φ}_{{i}_{m} , l} ( t ) = 1 \\ {E}_{{i}_{m} , m}^{bs} ( t ) , & {φ}_{{i}_{m} , m} ( t ) = 1 \\ {E}_{{i}_{m} , m , n}^{bs} ( t ) , & {φ}_{{i}_{m} , m , n} ( t ) = 1 \\ {E}_{{i}_{m} , c} ( t ) , & {φ}_{{i}_{m} , c} ( t ) = 1\end{matrix}$$
a processing cost of the task dᵢ_{ₘ}_{,m}(t) of the user iₘ is expressed as:
$${c}_{{i}_{m} , m} ( t ) = {α}_{{i}_{m} , m} {T}_{{i}_{m} , m} ( t ) + {ε}_{{i}_{m} , m} {E}_{{i}_{m} , m} ( t )$$
where αᵢ_{ₘ}_{,m} represents a weight coefficient of the processing delay, εᵢ_{ₘ}_{,m} represents a weight coefficient of the processing energy consumption, and αᵢ_{ₘ}_{,m} and εᵢ_{ₘ}_{,m} meet
$$\{ \begin{matrix}{α}_{{i}_{m} , m} + {E}_{{i}_{m} , m} = 1 \\ 0 \leq {α}_{{i}_{m} , m} \leq 1 \\ 0 \leq {ε}_{{i}_{m} , m} \leq 1\end{matrix} ; {T}_{{i}_{m} , l}^{loc} ( t )$$
represents a processing delay for processing the task locally,
$${T}_{{i}_{m} , m}^{bs} ( t )$$
processing delay for processing the task at an associated base station,
$${T}_{{i}_{m} , m , n}^{bs} ( t )$$
represents a processing delay for processing the task at a nearby base station, and Tᵢ_{ₘ}_{,c}(t) represents a processing delay for processing the task at a cloud;
φᵢ_{ₘ}_{,l}(t) represents that the task of the user i is processed locally, φᵢ_{ₘ}_{,m}(t) represents that the task of the user i is offloaded to an associated base station m for processing, φᵢ_{ₘ}_{,m,n}(t) represents that the task of the user i is forwarded from a base station n to the base station m for processing, and φᵢ_{ₘ}_{,c}(t) represents that the task of the user i is offloaded to the cloud for processing; and
$${E}_{{i}_{m} , l}^{loc} ( t )$$
represents a processing energy consumption for processing the task locally,
$${E}_{{i}_{m} , m}^{bs} ( t )$$
represents a processing energy consumption for processing the task at the associated base station,
$${E}_{{i}_{m} , m , n}^{b s} ( t )$$
represents a processing energy consumption for processing the task at the nearby base station, and Eᵢ_{ₘ}_{,c}(t) represents a processing energy consumption for processing the task at the cloud.

6. The policy learning method with privacy protection in mobile edge computing for an intelligent agent according to claim 1, wherein the optimization problem for task offloading, service caching, computing resource allocation and transmission power control comprises:
$$\begin{matrix}{min}_{a ( t ) , b ( t ) , β ( t ) , P ( t )} \frac{1}{T} \frac{1}{M} {\sum }_{t = 1}^{T} {\sum }_{m = 1}^{M} {\sum }_{{i}_{m} = 1}^{{N}_{m}} {c}_{{i}_{m} , m} ( t ) \\ s . t . {T}_{{i}_{m} , m} ( t ) \leq {C}_{{i}_{m} , m} ( t ) , ∀ {i}_{m} , ∀ m \\ {\sum }_{k = 1}^{K} {a}_{k , m} ( t ) \cdot {l}_{k} \leq {R}_{m} , {a}_{k , m} ( t ) ∈ \{ 0 , 1 \} , ∀ {i}_{m} , ∀ m \\ {\sum }_{i = 1}^{N} {β}_{{i}_{m} , m} ( t ) \leq 1 , 0 \leq {β}_{{i}_{m} , m} ( t ) \leq 1 , ∀ {i}_{m} , ∀ m \\ {φ}_{{i}_{m} , l} ( t ) , {φ}_{{i}_{m} , m} ( t ) , {φ}_{{i}_{m} , m , n} ( t ) , {φ}_{{i}_{m} , c} ( t ) ∈ \{ 0 , 1 \} , ∀ {i}_{m} , ∀ m \\ {φ}_{{i}_{m} , l} ( t ) + {φ}_{{i}_{m} , m} ( t ) + {φ}_{{i}_{m} , m , n} ( t ) + {φ}_{{i}_{m} , c} ( t ) = 1 , ∀ {i}_{m} , ∀ m\end{matrix}$$
where a(t)={a₁(t), . . . , a_{M}(t)} represents a service caching strategy for a base station, b(t)={b₁(t), . . . , b_{M}(t)} represents the task offloading strategy, β(t)={β₁(t), . . . , β_{M}(t)} represents a computing resource allocation strategy for the base station, P(t)={P₁(t), P₂(t), . . . , P_{M} (t)} represents the transmission power control decision, M represents the number of base stations, T represents a time slot, Nₘ represents the number of end users, cᵢ_{ₘ}_{,m}(t) represents a cost for processing a task dᵢ_{ₘ}_{,m}(t) of a user iₘ, Tᵢ_{ₘ}_{,m}(t) represents a processing delay of the task dᵢ_{ₘ}_{,m}(t) of the user iₘ, a_{k,m}(t) represents a caching decision for a service k of a base station m in a time slot t, lₖ represents a size of a storage space occupied by the service k, Rₘ represents a size of a storage space of a server of an m-th base station in the MEC scenario, βᵢ_{ₘ}_{,m}(t) represents a CPU frequency allocation coefficient allocated by the base station m for the user iₘ in the time slot t, φᵢ_{ₘ}_{,l}(t) represents that the task of the user i is processed locally, φᵢ_{ₘ}_{,m}(t) represents that the task of the user i is offloaded to the associated base station m for processing, φᵢ_{ₘ}_{,m,n}(t) represents that the task of the user i is forwarded from the base station m to a base station n for processing, φᵢ_{ₘ}_{,c}(t) represents that the task of the user i is offloaded to a cloud for processing, K represents a service type, and N represents the number of users.

7. The policy learning method with privacy protection in mobile edge computing for an intelligent agent according to claim 1, wherein abstracting a problem of minimizing the task processing costs to a partially observable Markov decision process comprises:
using a base station as the intelligence agent, and defining a tuple {S,O,A,R} to describe a Markov game process, wherein S represents a global state space, an environment in a time slot t is a global state s(t)∈S, O={O₁, O₂, . . . , O_{M}} represents a set of observation spaces for the intelligent agent, A={A₁, A₂, . . . , A_{M}} represents a set of global action spaces, and R={R₁, R₂, . . . , R_{M}} representing a set of rewards; and
selecting, by the intelligent agent based on a local observation oₘ(t)∈Oₘ, an action aₘ(t)∈Aₘ in the time slot t according to a strategy πₘ:Oₘ→Aₘ to obtain a corresponding reward rₘ(t)∈Rₘ.

8. The policy learning method with privacy protection in mobile edge computing for an intelligent agent according to claim 1, wherein the autonomously learning a task offloading strategy, a service caching strategy, a computing resource allocation strategy and a transmission power control strategy by using a federated learning-based multi-agent deep reinforcement learning algorithm comprises:
using a base station as the intelligent agent, wherein each of intelligent agents comprises an actor network and a critic network, the actor network comprises two deep neural networks: an actor current network and an actor target network, the critic network comprises two deep neural networks: a critic current network and a critic target network, and the intelligent agent further comprises an experience replay memory D;
in a training phase,
updating, by the actor network, a network parameter based on federated learning, and updating, by the critic network, a network parameter based on federated learning, wherein the critic current network updates a network parameter by minimizing a loss function, the actor current network updates a network parameter θ by maximizing a policy gradient based on a centralized Q-function calculated by the critic current network and observation information of the actor current network; and
updating parameters of the actor target network and the critic target network in a soft update manner, and performing parameter aggregation by using an attention mechanism; and
in a decentralized execution phase,
performing, by the actor network with updated parameter, an action decision based on a state of the intelligent agent; and
performing, by the critic network with updated parameter, evaluation on an action performed by the actor network, and guiding, by the critic network with updated parameter, the actor network to select an action;
wherein the experience replay memory D stores a tuple
$$D = \{ {o}_{m} ( t ) , {a}_{m} ( t ) , {r}_{m} ( t ) , {o}_{m}^{′} ( t + 1 ) \}$$
that is related to observations and actions in the training phase, oₘ(t) represents an observation state of an intelligent agent m in a time slot t, aₘ(t) represents an action performed by the intelligent agent m in the time slot t based on the current observation oₘ(t), rₘ(t) represents an obtained reward after the intelligent agent m performs the action aₘ (t) in the time slot t, and
$${o}_{m}^{′} ( t + 1 )$$
represents a state of the intelligent agent m in a time slot t+1;
wherein the performing, by the actor network, an action decision based on a state of the intelligent agent comprises:
performing, by an actor network of each of the intelligent agents in the time slot t, an action
$${a}_{m} ( t ) = {μ}_{m}^{{θ}_{m}} ( {o}_{m} ( t ) ; {θ}_{m} )$$
based on the local observation state oₘ(t) and a strategy
$${μ}_{m}^{{θ}_{m}} : {O}_{m} \to {A}_{m}$$
of the actor network in the decentralized execution phase, Oₘ represents a set of observation states of the intelligent agent m, Aₘ represents a set of action decisions of the intelligent agent m, and θₘ represents a parameter of the actor current network of the intelligent agent m, and
the action decisions comprise the task offloading strategy, the service caching strategy, the computing resource allocation strategy, and the transmission power control strategy.

9. The policy learning method with privacy protection in mobile edge computing for an intelligent agent according to claim 8, wherein the centralized Q-function is expressed as:
$${Q}_{m} ( {o}_{1} ( t ) , {o}_{2} ( t ) , … , {o}_{M} ( t ) , {a}_{1} ( t ) , {a}_{2} ( t ) , … , {a}_{M} ( t ) ; {ω}_{m} )$$
where Qₘ( ) represents the centralized Q-function, o₁(t), o₂(t), . . . , o_{M}(t) represent observation states of the intelligent agents, a₁ (t), a₂ (t), . . . , a_{M} (t) represent actions performed by the intelligent agents, and ωₘ represents a parameter of the critic current network.

10. The policy learning method with privacy protection in mobile edge computing for an intelligent agent according to claim 8, wherein the parameters of the actor current network, the critic current network, the actor target network and the critic target network are updated by:
updating, by the critic current network, the network parameter by minimizing the loss function, wherein the loss function is expressed as:
$${L}_{m} ( {ω}_{m} ) = E [ {( {Q}_{m} ( {o}_{1} ( t ) , {o}_{2} ( t ) , … , {o}_{M} ( t ) , {a}_{1} ( t ) , {a}_{2} ( t ) , … , {a}_{M} ( t ) ; {ω}_{m} ) - {y}_{m} )}^{2} ]$$
updating, by the actor current network, the network parameter θ by maximizing the policy gradient, wherein the policy gradient is expressed as:
$${∇}_{{θ}_{m}} J ( {θ}_{m} ) = E [ {∇}_{{θ}_{m}} {μ}_{j}^{{θ}_{m}} ( {a}_{m} ( t ) \vert {o}_{m} ( t ) ) \cdot {∇}_{{o}_{m} ( t )} {Q}_{m} ( {o}_{1} ( t ) , {o}_{2} ( t ) , … , {o}_{M} ( t ) , {a}_{1} ( t ) , {a}_{2} ( t ) , … , {a}_{M} ( t ) , {ω}_{m} ) \vert {a}_{m} ( t ) = {μ}_{m}^{{θ}_{m}} ( {o}_{m} ( t ) , {θ}_{m} ) ]$$
updating the parameters of the actor target network and the critic target network in the soft update manner based on the following equations:
$$\begin{matrix}{θ}_{m}^{′} = {τ}_{m}^{a} {θ}_{m} + ( 1 - {τ}_{m}^{a} ) {θ}_{m} \\ {ω}_{m}^{′} = {τ}_{m}^{c} {ω}_{m} + ( 1 - {τ}_{m}^{c} ) {ω}_{m}\end{matrix}$$
where Lₘ(ωₘ) represents the loss function, ∇ represents a gradient operation, J( ) represents a policy objective function to be optimized, E[ ] represents an expectation of a cumulative reward, θₘ represents the parameter of the actor current network of the intelligent agent m, oₘ(t) represents the observation state of the intelligent agent m, aₘ(t) represents the action decision of the intelligent agent m, Qₘ( ) represents the centralized Q-function, o₁(t), o₂(t), . . . , o_{M}(t) represent the observation states of the intelligent agents, a₁(t), a₂(t), . . . , a_{M}(t) represent the actions performed by the intelligent agents, yₘ represents a target Q-value function, ωₘ represents the parameter of the critic current network,
$${μ}_{m}^{{θ}_{m}}$$
represents a strategy of the intelligent agent m,
$${θ}_{m}^{′}$$
represents an updated parameter of the actor target network of the intelligent agent m,
$${ω}_{m}^{′}$$
represents an updated parameter of the critic target network of the intelligent agent m,
$${τ}_{m}^{a}$$
represents an update coefficient of the actor network and
$${τ}_{m}^{c}$$
represents an update coefficient of the critic network.
